(19) United States
(12) Patent Application Publication
(10) Pub. No.: US 2013/0283672 A1
(43) Pub. Date: Oct. 31, 2013

(54) CONTACT TRAP

(71) Applicant: Gunter Muller, Freising (DE)

(72) Inventor: Gunter Muller, Freising (DE)

(73) Assignee: MidMos Solutions Limited, Liverpool (GB)

(21) Appl. No.: 13/698,422

(22) PCT Filed: May 11, 2011
(86) PCT No.: PCT/GB2011/000715

§ 371 Date: Jun. 27, 2013

(30) Foreign Application Priority Data
May 17, 2010 (GB) 1008173.5

(51) Int. Cl. A01M 1/02; A01M 1/20; A01M 1/10

(52) U.S. Cl. CPC A01M 1/023; A01M 1/106; A01M 1/20
USPC 43/114; 43/132.1

(57) ABSTRACT

A contact trap for killing flying insects may include a combustion device for generating the attractants carbon dioxide, moisture and heat in situ in combination with an insecticide-impregnated target.

This invention relates to insect traps and more particularly to an improved contact trap and methodology for targeting mosquitoes and other biting insects, such as sand flies, in quest for a blood meal. The contact trap utilizes an insecticide which is transferred to the insect on contact to kill the insect, as opposed to trapping it with an adhesive.

### BACKGROUND

Mosquitoes and other biting insects (like sand flies, biting midges, stable flies, etc.) are annoying biting pests of humans, livestock, and wildlife. They cause distress by their painful bites, and furthermore some of the biting flies are vectors of diseases like Malaria, Dengue, Yellow Fever, West Nile Fever, Filariasis, and Leishmania, etc. One way of controlling and eliminating biting flies is through the use of traps. Traps generally have two functions:
a. First they attract the biting insects; and
b. Second they trap or kill them.

Attraction is achieved by mimicking a potential host like an animal or human. This may be with: optical cues like colour, pattern and shape; physical cues like heat (body heat ranging from 35 to 40° C.) and moisture; and chemical cues like scent (octenol, lactic acid, ammonia and other elements of body odours as well as CO2 (a major element of breath). Some traps use different types of light sources, most often UV, but light may also be used to disorientate flying night active.

After the biting flies are attracted close to the trap they need to be caught (arrested) or killed. This is most commonly achieved using suction (biting flies are drawn into netting bags or chambers), by glue boards, electric grids or combinations of these methods.

A major problem with traditional traps is that whilst in fact they can attract biting insects from areas up to 1.5 acres away, all of the attracted insects are not captured or killed. Research has infact shown that the biting pressure in some places with large traps can be higher than in places without traps. An ideal trap should be able to kill swiftly all the biting insects they attract.

The prior art, Journal of Vector Ecology 23(2):171-185 (1998), describes an attractant-based mosquito management technique which utilizes a target impregnated with an insecticide. The technique used carbon dioxide (200 cc/min) from bottles and octenol (4 mg/h) as attractants and an insecticide (lambda-cyhalothrin) impregnated shade cloth target (contact traps) to reduce mosquito abundance. The targets or contact traps were fairly crude comprising a cylindrical frame supporting a black shade cloth treated with an EC formulation (120 g/l) of lambda-cyhalothrin at 0.2 g A.l/m2. The sides and upper surface of the cylinders were covered with insecticide treated-cloth whilst the lower surface was “open” allowing insects to enter the inner surface of the target. The targets were suspended so the open lower surface was just above the ground and carbon dioxide was released from an external gas cylinder into the target together with octenol from a vial.

The goal of the research project was to develop a cost effective, environmentally friendly, attractant based operational mosquito management program.

Twelve years on from this research there has been little in the way of development in insecticide impregnated contact traps, rather industry efforts have focused on physically capturing and simultaneously killing the insects.

The two main commercial capture based traps are the Mosquito Magnet ™ which uses counter flow technology to emit a plume of carbon dioxide (generated by combustion), heat, octenol attractant and moisture, whilst simultaneously vacuuming the biting insects into a net where they dehydrate and die and The Mega-Catch Ultra ™ which keeps costs down by not using propane to generate carbon dioxide (and moisture) in situ and instead employs the chemical octenol in combination with LED and ultraviolet lights to attract mosquitoes.

Other art identified include the following:

US 2005/0126068 which discloses a bug killing device employing an electrified grid and/or a sticky umbrella to kill mosquitos. In one embodiment, a bait holding chamber is filled with an insecticide which may be distributed (in air currents). The surrounding umbrella may be a solid or a mesh and is coated with a sticky substance which captures attracted insects. It does not however teach an insecticide impregnated target, where killing is through the insect coming into contact with the insecticide by contacting the target.

WO2005/072522 teaches a device in which an insecticide is intermittently released from a canister and is directed to an area about the periphery, preferably in register with the release of carbon dioxide. The aim is to provide a cloud of insecticide about the periphery of the device. The disadvantage of such a system is that the insecticide is expelled into the local environment, where it may build up and potentially contaminates the site of use.

It is an object of the present invention to provide an improved insecticide coated contact trap and methodology for killing mosquitoes.

### BRIEF SUMMARY OF THE DISCLOSURE

In accordance with a first aspect of the present invention there is provided a contact trap for killing flying insects comprising a combustion device for generating the attractants carbon dioxide, moisture and heat in situ in combination with an insecticide-impregnated target.

The attractants, including at least carbon dioxide, moisture and heat, lure the insects to the insecticide-impregnated target where they come into contact with the insecticide, fly off and die. This overcomes a problem of having to capture the flying insects to kill them and the disadvantages associated therewith which add to the cost of the system.

Thus, an advantage of a contact trap comprising an insecticide impregnated target is that they can be left for longer in the field as, for example, there are no bags which will be clogged with dead insects and they are thus simpler to maintain.

Using a combustion device for generating the attractants carbon dioxide (moisture and heat) in situ has been demonstrated by the applicant to be more effective than introducing carbon dioxide from a cylinder as additionally the heat and moisture generated enhance the attractant effect—See Example 1. Furthermore, the heat generated can be used to improve humidity further by humidifying water and or volatilizing other attractants which can be provided for in the contact trap.

Combustion devices typically burn a hydrocarbon such as propane, butane or methane in air or oxygen to generate both carbon dioxide and water. The trap of the invention is thus designed with connections and valve assemblies for connection to gas or liquid hydrocarbon canisters.

Preferably the combustion device comprises a sealed burner unit and a catalytic converter to ensure efficient burning of the fuel to carbon dioxide and water vapor.

Preferably the insecticide-impregnated target comprises a fabric or mesh.

The insecticide can be any suitable insecticide as will be apparent to the skilled person and is not limited to lambda-cyhalothrin.

Preferably, the mesh is provided on a collapsible frame which can be easily hung or otherwise supported about an insect trap which uses a combustion device, such as those disclosed in WO9937145 or WO2005092020, the contents of which documents are incorporated by reference.

According to a further aspect of the present invention there is provided a method of killing flying insects comprising:
a. attracting the flying insect to a trap by the generation of a plume of carbon dioxide, heat and water vapour in situ using a combustion device; and
b. killing the flying insects by placing an insecticide coated target in close proximity to the plume such that when the flying insect comes into contact with the target the insecticide is transferred to the flying insect causing it to die.

The term “trap” as used in the specification does not necessitate the retaining of the flying insects within the device but is intended to cover devices which kill the insects as a consequence of them coming into contact with the trap.

In a preferred method the target is placed peripherally about a device generating the attractant.

### DETAILED DESCRIPTION

By way of example, a device of the invention will comprise at its simplest a combustion device for generating carbon dioxide, heat and moisture (as water vapor) from a hydrocarbon fuel source (as is disclosed in, for example WO9937145 or WO2005092020) but additionally incorporates an insecticide-impregnated target comprising a fabric or mesh.

The insecticide impregnated target may take the form of a collapsible tube (cylindrical or otherwise) which can be simply fitted or incorporated around a combustion chamber to form a trap. The tube may comprise an upper and lower frame which supports the fabric or mesh.

The insecticide impregnated target may comprise a handle allowing it to be dipped into an insecticide solution to allow it to be re-used. The handle will preferably project upward and or outward from the top of the target so as to prevent a user handling the insecticide coated part of the target.

The insecticide impregnated target comprises a means such as hooks or loops which allow it to be simply hung or otherwise connected over or around the combustor thus forming an insect trapping device.

That the generation of carbon dioxide, heat and moisture from a hydrocarbon fuel source provides significantly improved performance is demonstrated in Example 1 below:

### Example 1

Objective of the Study:

To compare the efficacy of a contact trap comprising an insecticide impregnated target which utilizes as an attractant bottled CO₂ with one utilising a combustion unit thereby additionally creating heat and moisture with the CO₂. The efficacy of the traps was determined by their ability to reduce the biting pressure of two common nuisance mosquito species after 24 hrs of operation.

Material and Methods:

The study was conducted in a green house complex in Israel. Experiments were performed in three compartments of empty green houses each with the dimension of 10×30×3 m (300 m²/900 m³) within six consecutive weeks. On the first day of each week 1000 female Culex pipiens and the same amount of female Aedes aegypti (mosquitoes) 5 days old, starved for 24 hrs (prior to the release) were set free in late afternoon in each of the three release chambers. Mosquitoes were given three hours to disperse in the chambers before a trap was placed in the centre of two chambers. One trap was an exact copy of the trap described by Kline & Lemire (1998) with carbon dioxide (200 cc/min from a bottle and octenol 4 mg/h) and an insecticide (lambda cyhalothrin) impregnated shade cloth target. The experimental trap was similar in shape, baited the same way with octenol, and the shade cloth target was impregnated with the same amount and type of insecticide but the CO₂ was instead derived from a combustion unit (creating 200 cc/min carbon dioxide) which additionally created heat and moisture. Later the traps were operated for 24 hrs while in the control chamber the mosquitoes were left alone. After 24 hrs the traps were removed and in the centre of each of the three chambers an entomologist was sitting on a chair collecting mosquitoes from his exposed legs for six time intervals each 5 min (with breaks of 5 min in between). The following six days of the week the reminding mosquitoes were starved to death within the release chambers.

There were, all together, six repetitions (releases) during which the two traps and the entomologists rotated between the three chambers.

Results:

The entomologists exposed to mosquitoes in the control chamber were bitten in 36 time intervals of 5 minutes 1606 times by Ae. aegypti and 1417 times by Cx. pipiens. Both traps were able to significantly reduce the biting pressure of the two mosquito species compared to the control after operation of 24 hours. The entomologists which were in the chambers with the contact trap with bottled CO₂ were, during the experiment, bitten by mosquitoes (235/94 Ae. aegypti and 302/132 Cx. pipiens) more than twice as often as the ones who were in the chambers with the contact trap with a combustion unit.

The results are tabulated in Table 1 below:

TABLE 1

| | | CONTROL | | Contact/bottled CO2 | | Contact/combustion | |
|---|---|---|---|---|---|---|---|
| | | Ae. aegypti | Cx. pipiens | Ae. aegypti | Cx. pipiens | Ae. aegypti | Cx. pipiens |
| Rep. I | interv. 1 | 48 | 35 | 8 | 5 | 5 | 3 |
| | interv. 2 | 33 | 27 | 3 | 7 | 7 | 4 |
| | interv. 3 | 28 | 38 | 11 | 15 | 1 | 0 |
| | interv. 4 | 42 | 29 | 6 | 3 | 0 | 2 |
| | interv. 5 | 19 | 15 | 6 | 11 | 3 | 0 |
| | interv. 6 | 52 | 46 | 2 | 4 | 0 | 1 |
| Rep. II | interv. 1 | 40 | 32 | 15 | 10 | 3 | 5 |
| | interv. 2 | 65 | 58 | 8 | 5 | 0 | 3 |
| | interv. 3 | 31 | 27 | 5 | 8 | 7 | 2 |
| | interv. 4 | 38 | 43 | 9 | 4 | 2 | 4 |
| | interv. 5 | 47 | 55 | 3 | 11 | 0 | 0 |
| | interv. 6 | 58 | 40 | 2 | 5 | 1 | 2 |
| Rep. III | interv. 1 | 19 | 24 | 7 | 12 | 3 | 4 |
| | interv. 2 | 26 | 16 | 3 | 3 | 1 | 2 |
| | interv. 3 | 35 | 30 | 5 | 4 | 0 | 6 |
| | interv. 4 | 22 | 12 | 2 | 9 | 5 | 0 |
| | interv. 5 | 30 | 28 | 8 | 5 | 2 | 2 |
| | interv. 6 | 17 | 17 | 4 | 10 | 0 | 4 |
| Rep. IV | interv. 1 | 50 | 39 | 8 | 13 | 3 | 8 |
| | interv. 2 | 73 | 68 | 5 | 7 | 2 | 5 |
| | interv. 3 | 46 | 35 | 3 | 5 | 0 | 3 |
| | interv. 4 | 38 | 31 | 14 | 20 | 4 | 0 |
| | interv. 5 | 63 | 54 | 5 | 6 | 0 | 3 |
| | interv. 6 | 59 | 46 | 6 | 9 | 5 | 4 |
| Rep. V | interv. 1 | 33 | 27 | 3 | 8 | 0 | 5 |
| | interv. 2 | 25 | 19 | 4 | 4 | 7 | 2 |
| | interv. 3 | 44 | 38 | 0 | 17 | 2 | 11 |
| | interv. 4 | 50 | 46 | 8 | 6 | 1 | 3 |
| | interv. 5 | 39 | 35 | 2 | 12 | 0 | 6 |
| | interv. 6 | 27 | 30 | 5 | 5 | 3 | 5 |
| Rep. VI | interv. 1 | 71 | 60 | 25 | 20 | 9 | 14 |
| | interv. 2 | 66 | 57 | 5 | 3 | 2 | 5 |
| | interv. 3 | 83 | 73 | 13 | 10 | 0 | 0 |
| | interv. 4 | 55 | 49 | 8 | 9 | 3 | 2 |
| | interv. 5 | 60 | 68 | 4 | 6 | 11 | 4 |
| | interv. 6 | 74 | 70 | 10 | 11 | 2 | 8 |
| total: | | 1606 | 1417 | 235 | 302 | 94 | 132 |

| | | | | | | |
|---|---|---|---|---|---|---|
| av. bites/5 min: | 44.61 | 39.36 | 6.53 | 8.39 | 2.61 | 3.67 |

| | | | | |
|---|---|---|---|---|
| reduction of biting pressure: | 85.36% | 78.86% | 94.15% | 90.07% |

1. A contact trap for killing flying insects, comprising: a combustion device for generating the attractants carbon dioxide, moisture and heat in situ in combination with an insecticide-impregnated target.

2. A contact trap as claimed in claim 1, wherein the combustion device includes a sealed burner unit connected to a hydrocarbon fuel.

3. A contact trap as claimed in claim 1, further comprising a catalytic convertor.

4. A contact trap as claimed in claim 1, wherein the insecticide-impregnated target comprises at least one of a fabric and a mesh.

5. A contact trap as claimed in claim 4, wherein the at least one of a fabric and a mesh is of a dark colour.

6. A contact trap as claimed in claim 4, wherein the at least one of a fabric and a mesh is supported on a frame.

7. A contact trap as claimed in claim 6, wherein the target is hung vertically from the frame.

8. A contact trap as claimed in claim 6, wherein the frame is a collapsible frame.

9. A contact trap as claimed in claim 1, wherein the insecticide-impregnated target surrounds the combustion device.

10. A contact trap as claimed in claim 1, wherein the insecticide-impregnated target is adapted to be hung around the combustion device.

11. A contact trap as claimed in claim 1 wherein the insecticide-impregnated target comprises a handle mechanism for means allowing it to be re-impregnated with insecticide at regular intervals.

12. A method of killing flying insects comprising:
attracting the flying insect to a trap by the generation of a plume of carbon dioxide, heat and water vapour in situ using a combustion device; and
killing the flying insects by placing an insecticide coated target in close proximity to the plume such that when the flying insect comes into contact with the target the insecticide is transferred to the flying insect causing it to die.

13. A method of killing flying insects as claimed in claim 12, wherein the target is placed peripherally about the combustion device.

14. A contact trap as claimed in claim 2, further comprising a catalytic convertor.

15. A contact trap as claimed in claim 14, wherein the insecticide-impregnated target comprises at least one of a fabric and a mesh.

16. A contact trap as claimed in claim 15, wherein the at least one of a fabric or and a mesh is of a dark colour.

17. A contact trap as claimed in claim 16, wherein the at least one of a fabric or and a mesh is supported on a frame.

18. A contact trap as claimed in claim 17, wherein the target is hung vertically from the frame.

19. A contact trap as claimed in claim 18, wherein the frame is a collapsible frame.

20. A contact trap as claimed in claim 19, wherein the insecticide-impregnated target surrounds the combustion device.
